(19) United States
(12) Patent Application Publication
(10) Pub. No.: US 2011/0221150 A1
(43) Pub. Date: Sep. 15, 2011

(54) SKATEBOARD DECK HAVING ADJUSTABLE TRUCK MOUNTING SYSTEM

(76) Inventor: Brock Harris, Draper, UT (US)

(21) Appl. No.: 12/883,133

(22) Filed: Sep. 15, 2010

Related U.S. Application Data
(60) Provisional application No. 61/243,101, filed on Sep. 16, 2009.

(51) Int. Cl. A63C 17/02; B32B 3/30; B32B 3/10; B23P 17/04

(52) U.S. Cl. 280/87.042; 428/172; 428/137; 29/428

(57) ABSTRACT

A skateboard deck includes an adjustment attachment mechanism which allows one or more trucks to be attached to the skateboard deck at a variety of positions to thereby change the use dynamics of a resulting skateboard.

### PRIORITY

The present application claims the benefit of U.S. Provisional Application Ser. No. 61/243,101, filed Sep. 16, 2009, which is herein incorporated by reference in its entirety.

### THE FIELD OF THE INVENTION

The present invention relates to a skateboard deck having an adjustable truck mounting system. In particular, the present invention relates to a system which allows the trucks of a skateboard to be mounted in different relative locations along the deck to thereby change the dynamics of the skateboard when in use.

### BACKGROUND

Skateboarding has been a popular sport in the United States and other countries for several decades. As the sport has evolved, there has been an increase in the number of skateboard configurations that are available. Typically, a skateboard includes two pairs of wheels. The wheels are mounted to trucks which can pivot to enable steering of the skateboard.

Disposed on the top of the trucks is a riser which is typically formed from a synthetic rubber-like material. The riser provides cushioning between the truck and a skateboard deck on which the user stands. Each truck and riser is typically attached to the skateboard by four screws which extend through the deck, through the riser, and an upper portion of the truck and engage a bolt to hold the truck and riser to the deck.

There are several factors which affect the performance of a skateboard. These include the length of the skateboard, the width of the trucks between the wheels, the distance between the trucks adjacent opposing ends of the skateboard, and even the height and weight of the person using the skateboard. Because of these differences, there are numerous dozens of different sizes and designs which can be purchased at locations that sell skateboards.

While some individuals may like a particular length or style of board, the performance characteristics of the board may not be as desired for that rider. For example, a person who is riding a skateboard for speed will typically want the trucks spaced far apart so the skateboard is stable and maneuvers smoothly through turns. In contrast, in other situations, a person riding a skateboard may desire to have a skateboard with a shorter distance between the trucks to provide a shorter turning radius and more maneuverability.

Prior to the present invention, a user simply had to trade skateboards or drill new holes in the skateboard to relocate the trucks and thereby change the skateboards' use dynamics. Thus, there is a need for an improved method for adjusting a skateboard to the desired dynamics of the user.

### SUMMARY OF THE INVENTION

In accordance with the above and other objects of the invention, an adjustable truck mounting system is provided which allows a user to select the positioning of trucks relative to the deck. In accordance with one aspect of the invention, the skateboard is provided with at least one adjustable truck mount having a plurality of holes so as to enable a truck to be placed in a plurality of different positions along the length of the skateboard deck.

In accordance with another aspect of the invention, a pair of plates is provided with at least one of the plates having a plurality of holes sufficient to allow adjustment to the position of the truck along the length of the deck. The plates are typically disposed in one or more upper layers and one or more lower layers of a skateboard deck. The plurality of holes in the inserts allow the screws used to attach the trucks to the deck to be placed in a plurality of different locations thereby allowing a user to adjust the exact positioning of the trucks relative to the deck.

In accordance with another aspect of the invention, the two pairs of inserts are used—one for the front truck and the second for the rear truck. The inserts allow the front truck to be positioned closer to or further away from the front of the deck of the skateboard, and to vary the distance between the two sets of trucks. Likewise, the rear insert enables the distance between the rear truck and the rear end of the deck to be adjusted as well as adjustment between the opposing ends of the skateboard.

The adjustable truck mounting system disclosed in the present invention thus allows a user to customize his or her ride on a skateboard. For example, a user who prefers to place their foot towards the very front of the deck may move the trucks forward to reduce the risk that the user inadvertently steps on the nose of the board and causes the back of the deck to flip up. Likewise, by adjusting the position of the front and back trucks, the user can use the same skateboard for racing at high speeds and for situations in which greater maneuverability is required.

### BRIEF DESCRIPTION OF THE DRAWINGS

Various embodiments of the present invention are shown and described in reference to the numbered drawings wherein:

FIG. 1 shows a top view of a skateboard having a plurality of inserts disposed therein in accordance with the principles of the present invention;

FIG. 1A shows a top view of the skateboard of FIG. 1 having the inserts removed;

FIG. 2 shows a cross-section of a skateboard taken through line 2-2 in FIG. 1;

FIG. 3 shows a fragmented longitudinal cross-sectional view of the front portion of the skateboard deck shown in FIG. 1;

FIG. 4A shows one embodiment of the inserts which may be disposed in the skateboard in accordance with an aspect of the invention; and

FIG. 4B shows an alternate configuration of inserts which may be used in accordance with the principles of the present invention.

It will be appreciated that the drawings are illustrative and not limiting of the scope of the invention which is defined by the appended claims. The embodiments shown accomplish various aspects and objects of the invention. It is appreciated that it is not possible to clearly show each element and aspect of the invention in a single figure, and as such, multiple figures are presented to separately illustrate the various details of the invention in greater clarity. Similarly, not every embodiment need accomplish all advantages of the present invention.

### DETAILED DESCRIPTION

The invention and accompanying drawings will now be discussed in reference to the numerals provided therein so as to enable one skilled in the art to practice the present invention. The drawings and descriptions are exemplary of various aspects of the invention and are not intended to narrow the scope of the appended claims.

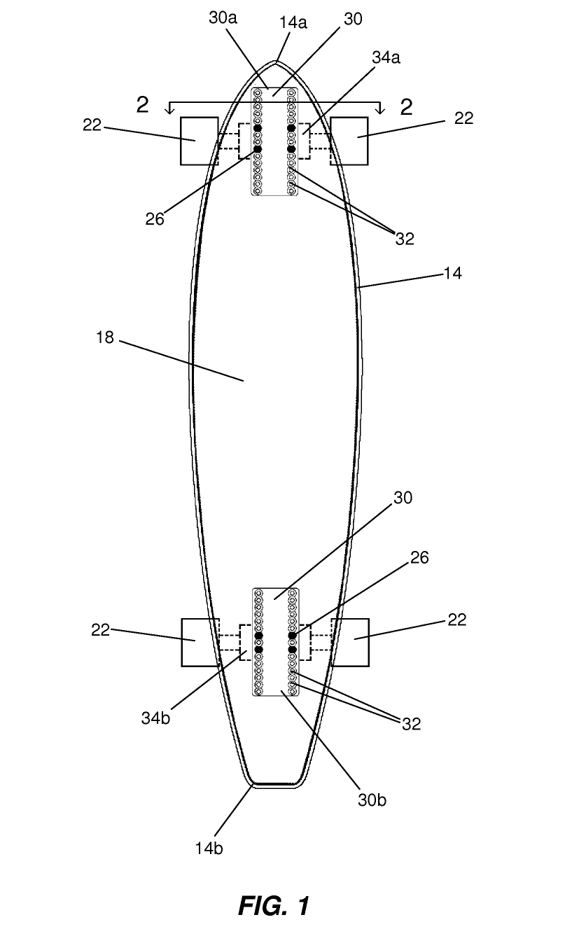

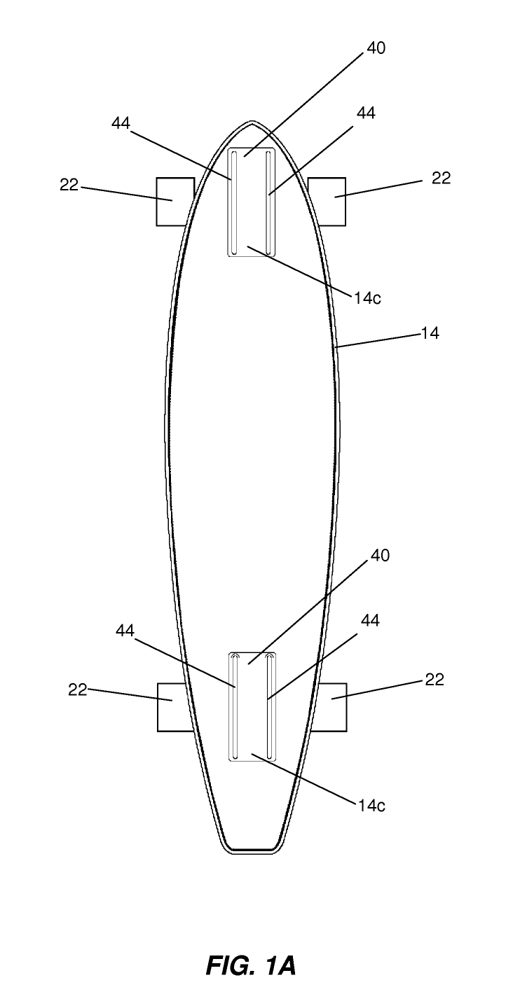

Turning now to FIG. 1 there is shown a top view of a skateboard, generally indicated at 10 made in accordance with the present invention. The skateboard includes a deck 14 on which a user stands. Typically, the deck 14 is provided with grip paper 18, which is somewhat similar to sandpaper and provides traction for a user's feet. The skateboard also includes a plurality of wheels 22 which are mounted to the skateboard by trucks and risers (shown in shadow 34a and 34b) which are attached to the deck by a plurality of screws 26. In a conventional skateboard four holes will be drilled in the deck adjacent the front end of the deck with an additional four holes screwed in the deck adjacent the rear end. The screws are inserted through the holes and attached to the risers and trucks. The trucks hold the wheels to the deck and allow them to pivot when a user leans to one side or the other of the skateboard.

In the present invention, one or more inserts 30 are disposed in the deck 14. A front insert 30a is disposed adjacent the nose 14a of the skateboard. The insert includes a plurality of holes 32 through which the screws can be inserted. Typically, the insert would be anywhere from three to six inches (7.6 to 15. cm) with an insert between five and five and a half inches (12.7 to 14 cm) being presently preferred. The thickness of the inserts 30 is typically between 1/16th and ⅛th of an inch thick, with about 1/12th to 1/10th of an inch (2 to 3 mm) being presently preferred.

In such a manner, the trucks 34 can be moved forward or rearward from their conventional location by two or three inches. Assuming the rear trucks 34b are in a conventional position, this allows the user to change the wheel base of the skateboard by a couple of inches forward or backward to change in the dynamics of the skateboard. For example, the greater the wheel base between the front and rear trucks the better handling the skateboard will be at high rates of speed. In contrast, the shorter the distance between the trucks will provide greater maneuverability.

As with the front trucks 34a, the rear trucks 34b are disposed adjacent the tail 14b of the deck. The insert 34b allows the trucks to be moved forward or rearward by a couple of inches. When two inserts are used together, the distance between the trucks can be varied by, for example, about six inches. This can create a significant change in the turning radius and other performance characteristics of the board.

By providing the two inserts and forming an adjustable truck mounting system, the user of a skateboard can use a single board for a variety of activities. For example, a skateboarder attempting to do tricks with the skateboard may move the trucks closer together to make the skateboard more maneuverable and facilitate the desired tricks. In contrast, if the skateboarder is going to take his or her skateboard into a race down an extended incline, the skateboarder can merely remove the screws, move the front truck toward the front of the front insert and the rear truck toward the rear of the rear insert to provide the board better handling and control at high rates of speed.

Turning now to FIG. 1A, there is shown a top view of the skateboard 10 with the inserts 30 removed. The deck 14 includes a pair of cut-outs 40 or detents which extend into the deck. Typically, the cut-outs will be between 2-3 layers of the layers of wood which are glued together to form the skateboard deck. The middle layers 14c of the deck 14 may be left to maintain rigidity in the board and to give a surface against which the inserts 30 (FIG. 1) can be held.

A plurality of openings 44 are formed or cut into the middle layers 14c to facilitate passage of screws therethrough. The openings 44 can be elongate slots or a plurality of holes. Configured to align with the holes 32 (FIG. 1) in the inserts 30 (FIG. 1). When the inserts 30 are in the cut-outs 40, it will be appreciated that tightening the screws will cause the inserts to press firmly against the middle layers 14c of the deck. (While the term cut-out is used, it will be appreciated that opening could be molded in a formed material which forms part of the board and the term cut-outs is understood the cover such a configuration).

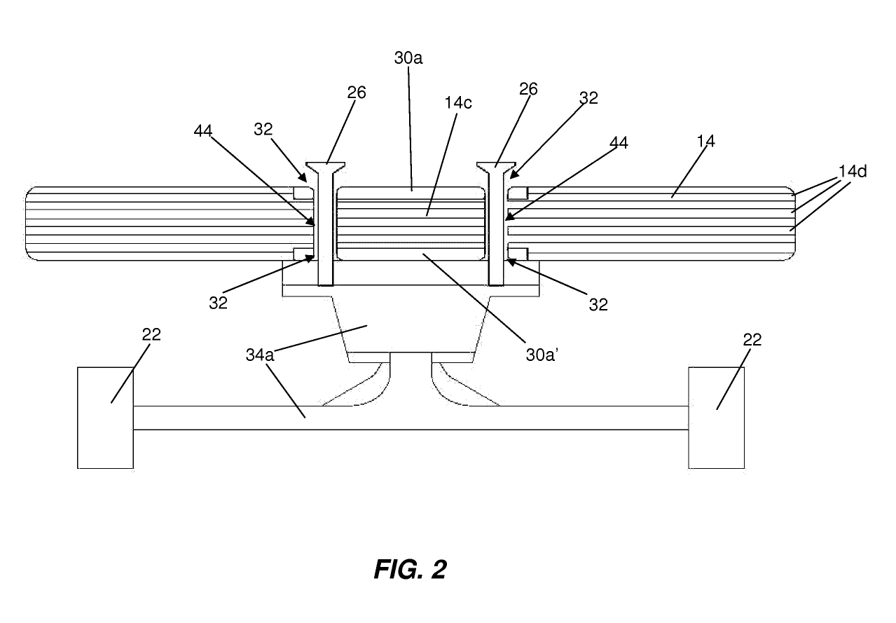

Turning now to FIG. 2 there is shown a cross-sectional view taken through the front insert 30a. (The discussion herein may be equally applicable to the rear insert 30b.) Typically, a skateboard is made from seven to nine layers of wood 14d which are formed and glued together. In a preferred embodiment of the present invention, two or three of the top layers are cut away sufficiently to allow receipt of the top insert 30a′. The bottom two or three layers of the skateboard are also cut away to receive a bottom insert 30a″. The remaining layers 14d of the skateboard deck 14 are left between the inserts with openings 44 corresponding to the holes 32 in the inserts so that screws can pass through the board. Preferably, the holes 32 in the upper insert 30a′ are countersunk to allow the head of the screw 26 to be substantially co-planar with the top of the insert when the screw passes through the deck 14.

Also shown in FIG. 2 are the front truck 34a and the riser 38 which is positioned beneath the deck 14. When the screw 26 extends through the inserts 30a and 30a′ and the middle layer(s) 14 of the deck 14, it engages the truck 34a (or a bolt, not show) and thereby holds the truck 34a to the deck. However, because the holes 32 in the inserts 30a and the openings slots in the middle layer(s) 14c, the user can attach the truck 34 to a plurality of locations along the deck to change the use dynamics of the skateboard.

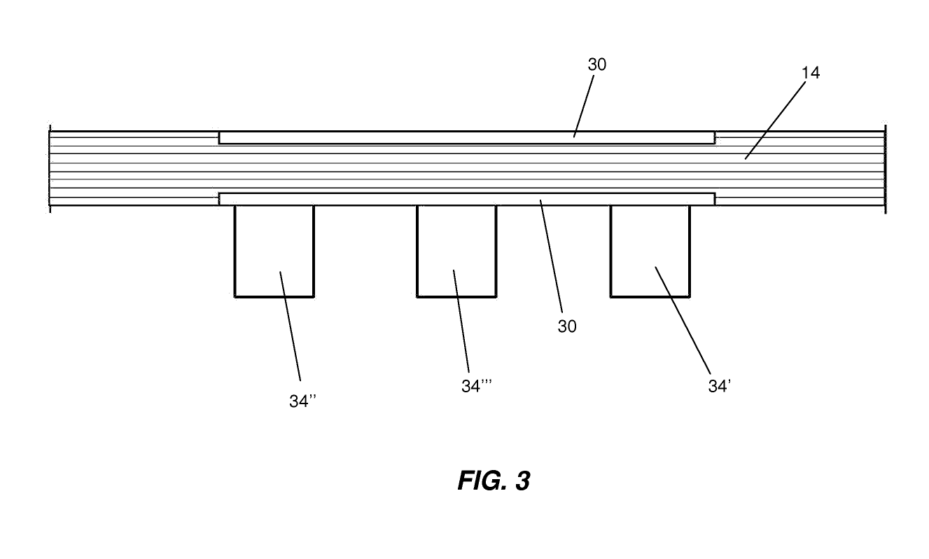

Turning now to FIG. 3, there is shown a side cross-sectional view of the front end of a skateboard deck 14 taken through the plates. It will be appreciated that the trucks 34 can be moved to numerous positions along the inserts 30 to thereby change both the distance of the trucks from each other and the distance of the trucks from either end of the deck 14. For example the box 34′ representing a truck in a forwardmost position may represent the position desired by a user who will be involved in a road race down an extended incline or a user who likes to stand at the very front end of the deck. Box 34″ shows a position conducive with making the skateboard as maneuverable as possible, while box 34′″ may represent the position of the trucks on a conventional skateboard. The present invention enables a user to customize their skateboard in light of their riding style and desired use of the skateboard.

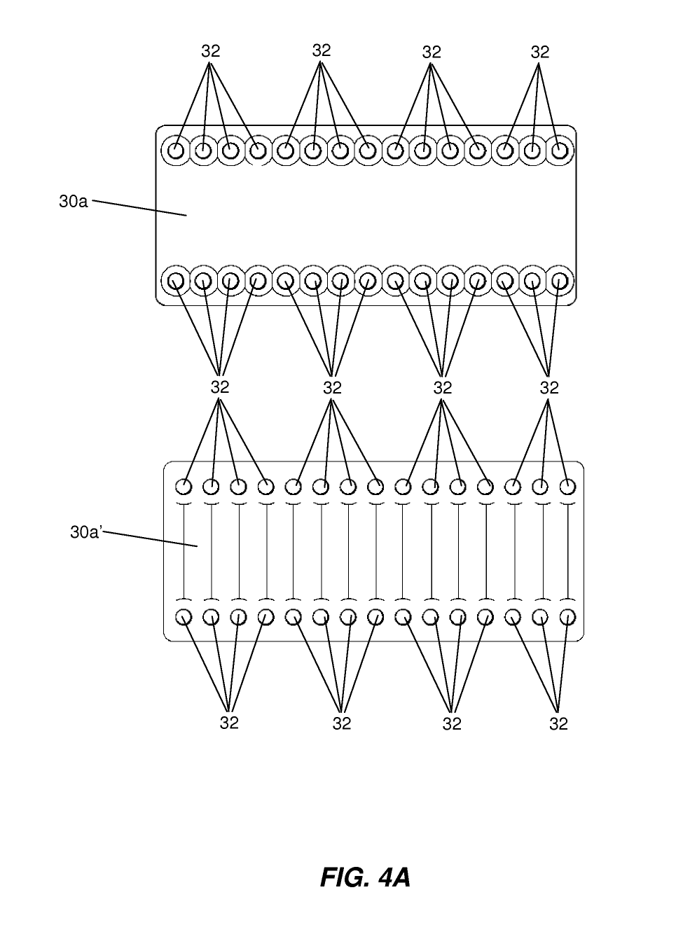

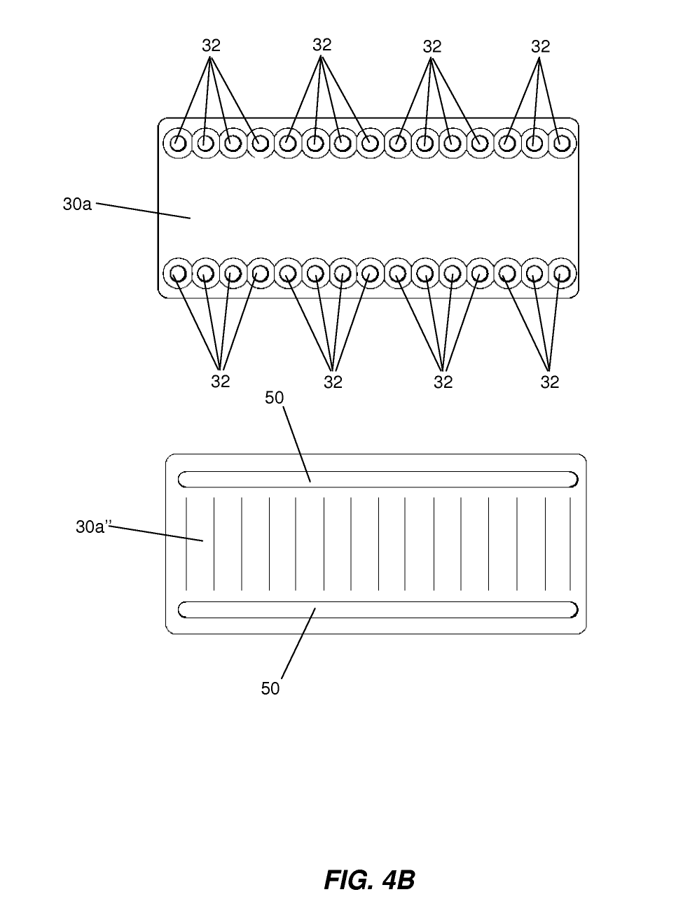

Turning now to FIG. 4A, there is shown one configuration of the inserts. The inserts each comprise a plurality of holes 32 in alignment with one another so that the screws may be placed through the upper insert 30a and the lower insert 30a′. It is preferred that the upper surface of the holes 32 in the upper insert 30a be beveled so as to allow the screws to countersink so that top of the screw does not extend any meaningful distance above the top of the insert. The holes in the lower insert 30a′ can be beveled if desired to allow interchangeability with the upper insert or can simply be provided with a flat surface to lower the cost of manufacturing. (It will be appreciated that the inserts for the rear of the skateboard could be made in the same manner as described with respect to FIG. 4A.)

FIG. 4B shows an alternate configuration of the inserts 30. While the top insert 30a′ includes a plurality of holes 32, the lower insert 30a″ includes a pair of channels 50 that align with the openings 44 (holes, channels or slots) in the middle layer(s) 14c (FIG. 2) of the deck 14. This allows any offset between the position of the upper cut-out and the lower cut-out to be disregarded, as the inserts can be offset longitudinally without preventing attachment.

There is thus disclosed an improved skateboard having an adjustable truck attachment system. It will be appreciated that numerous changes may be made to the present invention without departing from the scope of the claims.

What is claimed is:

1. A skateboard deck having:
at least one cut-out formed therein: and
at least one insert disposed in the cut-out, the insert providing multiple points of attachment for a skateboard truck.

2. The skateboard deck according to claim 1, wherein the at least one cut-out comprises a first cut-out and a second cut-out in a top side of the deck, the first cut out being disposed adjacent one end and the second cut-out being disposed adjacent an opposing end.

3. The skateboard deck according to claim 2, wherein the at least one insert comprises an insert disposed in the first cut-out and an insert disposed in the second cut-out.

4. The skateboard deck according to claim 3, wherein at least one of the inserts comprises a plurality of holes disposed along the insert, the plurality of holes being sufficient in number to allow a truck to be properly attached at a plurality of locations along the insert.

5. The skateboard deck according to claim 1, further comprising a pair of openings extending from the at least one cut-out through the deck of the skateboard.

6. The skateboard deck according to claim 5, wherein the deck comprises a top side and a bottom side and wherein the at least one cut out comprises a first cut-out disposed in the top side and a second cut-out disposed in the bottom side in alignment with the first cut-out, and wherein the openings extend between the first cut-out and the second cut-out.

7. The skateboard deck according to claim 1, wherein the deck has a top side and a bottom side and wherein the at least one cut-out comprises a cut out on the top side of the deck and a cut-out on the bottom side of the deck.

8. The deck for a skateboard of claim 7, wherein the at least one insert comprises an insert disposed in the top of the deck and an insert disposed in the bottom of the deck.

9. A skateboard comprising the deck of claim 7 and further comprising a pair of trucks attached to the deck.

10. The skateboard deck according to claim 1, wherein the at least one insert is formed from metal.

11. A method for forming a skateboard deck comprising:
forming a deck having a plurality of layers of wood and a cut-out in the deck;
inserting an insert having a plurality of holes into the deck, the holes being configured to receive screws to attach a skateboard truck to the deck at a plurality of different locations.

12. The method according to claim 11, wherein the method comprises forming a deck to have cut-outs on a top side and a bottom side of the deck so that the cut-outs are in alignment with one another.

13. The method according to claim 12, wherein the method further comprises disposing an insert in to cut-out on the top side and another insert in the cut-out on the bottom side.

14. A method of making a skateboard according to the method of claim 11, and further comprising passing a plurality of screws through the inserts to attach a truck to the inserts.

15. The method of claim 11, wherein the method comprises forming a deck having cut-outs and inserts adjacent a front end of the deck and adjacent the rear end of the deck and attaching a pair of trucks to the deck so that the position of the trucks can be moved relative to the deck without drilling additional holes in the deck.

16. A skateboard comprising:
a skate board deck;
a first skateboard truck having wheels attached to the deck;
a mounting location on the skateboard deck;
a second skateboard truck having wheels attached to the mounting location; and
wherein the second skateboard truck is selectively mountable at a plurality of locations disposed longitudinally along the length of the skateboard mounting location;

17. The skateboard of claim 16, wherein the mounting location comprises a plurality of holes disposed longitudinally along the mounting location.

18. The skateboard of claim 16, wherein the mounting location comprises a recess formed in the skateboard deck and an insert disposed in the recess.

19. The skateboard of claim 18, wherein the insert comprises a plurality of holes disposed along the length thereof, the second skateboard truck being mounted to some of said plurality of holes.

20. The skateboard of claim 19, wherein the insert is metal.
